(19) United States
(12) Patent Application Publication
(10) Pub. No.: US 2025/0337017 A1
(43) Pub. Date: Oct. 30, 2025

(54) BATTERY

(71) Applicant: ZHUHAI COSMX BATTERY CO., LTD., Zhuhai (CN)

(72) Inventors: Yaming QIU, Zhuhai (CN); Hai WANG, Zhuhai (CN); Suli LI, Zhuhai (CN)

(73) Assignee: ZHUHAI COSMX BATTERY CO., LTD., Zhuhai (CN)

(21) Appl. No.: 19/264,006

(22) Filed: Jul. 9, 2025

Related U.S. Application Data
(63) Continuation of application No. PCT/CN2023/141066, filed on Dec. 22, 2023.

(30) Foreign Application Priority Data
Feb. 14, 2023 (CN) 202310112712.1

(51) Int. Cl. H01M 10/0567; H01M 10/0525

(52) U.S. Cl. CPC H01M 10/0567; H01M 10/0525; H01M 2300/0025

(57) ABSTRACT

A battery includes a positive and a negative electrode plate, a separator, and an electrolyte solution. The additives of the electrolyte solution include tricyanophosphite compounds and alkyl polycyanide compounds. It can solve problems of large side reactions between electrolyte solution and electrode interface, and the significant deterioration of high-temperature cycling performance and high-temperature storage performance of the battery under high voltage. By adding an appropriate amount of electrolyte additive according to the areal density of the positive electrode, it is possible to form a very stable interface film and interface coordination effect on the positive electrode, significantly improving the stability of the electrolyte solution and the positive electrode interface, reducing the consumption of the electrolyte solution and the damage to the positive electrode structure during battery cycling, and significantly enhancing the high-temperature cycling performance and high-temperature storage performance of the battery at high voltage.

### CROSS-REFERENCE TO RELATED APPLICATIONS

This application is a continuation application of the International Application No. PCT/CN2023/141066, filed on Dec. 22, 2023, which claims priority to Chinese Patent Application No. 202310112712.1, filed on Feb. 14, 2023. All of the aforementioned applications are incorporated herein by reference in their entireties.

### TECHNICAL FIELD

The present disclosure relates to the technical field of batteries, and in particular, to a battery with good high-temperature cycling performance and high-temperature storage performance.

### BACKGROUND

Over the past decade, lithium battery technology has made rapid progress. It not only has increasingly high energy density but also excellent cycling performance, thus being widely applied in various mobile electronic products such as mobile phones, laptops, and Bluetooth headphones. It is also increasingly used in power fields such as power tools and electric vehicles. How to further increase the energy density of lithium batteries has become the focus and hotspot of research.

Without major system changes, the increase in battery energy density can be achieved simply by raising the battery voltage. Lithium cobalt oxide is a commonly used high-voltage positive electrode material for large-scale commercialization. Increasing the charging and discharging voltage of batteries not only boosts the platform voltage but also enhances the specific capacity of the positive electrode, thereby increasing the energy density of the battery. However, an increase in battery voltage will intensify the side reactions between the electrolyte solution and the positive and negative electrode interfaces, thereby deteriorating the battery's cycling performance.

To enhance the high-voltage cycling stability of batteries, in addition to adjusting the solvent components in the electrolyte solution, adding additives has become the most commonly used and effective approach. However, as the battery voltage further increases, the strategy of adding additives becomes increasingly difficult to play a sufficient role in stabilizing the high-temperature and high-pressure performance of the battery. Therefore, the development of new and effective positive electrode protection strategies becomes even more important.

### SUMMARY

To address the issue of significant side reactions between the electrolyte solution and the electrode interface in batteries at high voltages, as well as the obvious deterioration of the battery's high-temperature cycling performance and high-temperature storage performance at high voltages, the present disclosure provides a battery. The battery includes a positive electrode plate, a negative electrode plate, a separator and an electrolyte solution. The additives of the electrolyte solution include tricyanophosphite compounds and alkyl polycyanide compounds. Through the synergistic effect between the areal density of the positive electrode and the additives of the electrolyte solution, a very stable interface film and interface coordination effect can be achieved at the positive electrode, significantly enhancing the stability of the interface between the electrolyte solution and the positive electrode. Reduce the consumption of electrolyte solution and the damage to the positive electrode structure during battery cycling, significantly improving the battery's high-temperature cycling performance and high-temperature storage performance at high voltages.

The purpose of the present disclosure is achieved through the following technical solution.

A battery includes a positive electrode plate, a negative electrode plate, a separator, and an electrolyte solution. The electrolyte solution includes a lithium salt, an organic solvent, a first additive that includes a tricyanophosphite compound, and a second additive that includes an alkyl polycyanide compound.

The battery satisfies the following relationship: A≥B/10, where A is a total mass percentage of the first additive and the second additive in the total mass of the electrolyte solution; B is the areal density of the positive electrode, in units of mg/cm².

The beneficial effects of the present disclosure are as follows.

The present disclosure provides a battery, which includes a positive electrode plate, a negative electrode plate, a separator, and an electrolyte solution. The additives of the electrolyte solution include a tricyanophosphite compound and an alkyl polycyanide compound. The battery can solve the problem of large side reactions between the electrolyte solution and the electrode interface under high voltage, and the significant deterioration of high-temperature cycling performance and high-temperature storage performance of the battery under high voltage.

### DETAILED DESCRIPTIONS OF THE EMBODIMENTS

The following will further illustrate the technical solutions of the present disclosure in detail with specific embodiments. It should be understood that the following embodiments are merely illustrative and explanatory of the present disclosure and should not be construed as limiting the scope of protection of the present disclosure. Any technology realized based on the above content of the present disclosure is covered within the scope of protection intended by the present disclosure.

The experimental methods used in the following embodiments are conventional methods unless otherwise specified; the reagents, materials, etc. used in the following embodiments can be obtained commercially unless otherwise specified.

In the description of the present disclosure, it should be noted that the terms ‘first’, ‘second’, etc. are used for descriptive purposes only and are not intended to indicate or imply relative importance.

The present disclosure provides a battery, including a positive electrode plate, a negative electrode plate, a separator, and an electrolyte solution. The electrolyte solution includes a lithium salt, an organic solvent, a first additive, and a second additive. The first additive includes a tricyanophosphite compound, and the second additive includes an alkyl polycyanide compound.

The battery satisfies the following relationship: A≥B/10, where A is a total mass percentage of the first additive and the second additive in the total mass of the electrolyte solution; B is the areal density of the positive electrode, in units of mg/cm².

In the present disclosure, when calculating the parameters involved in the relationship, only the numerical values are calculated, and their units are not considered. For example, when the total mass of the first additive and the second additive accounts for 0.5% of the total mass of the electrolyte solution, A is 0.5; when the areal density of the positive electrode plate is mg/cm², B is 20.

According to some embodiments of the present disclosure, the first additive includes a tricyanophosphite compound, and the second additive includes an alkyl polycyanide compound.

The two additives can jointly act on the surface of the positive electrode. Specifically, the tricyanophosphite compound contains both a phosphite ester functional group and an alkyl polycyanide functional group. The phosphite ester functional group is easily oxidized on the positive electrode to form a phosphorus-rich dense protective film to protect the positive electrode, while the formed film will bring the alkyl polycyanide functional group to the positive electrode interface. The alkyl polycyanide functional group has a strong coordination effect with the transition metal at the positive electrode interface, which can enhance the protection of the positive electrode and make the formed phosphorus-containing protective film more robust. The simultaneously added alkyl polycyanide compound can further coordinate with the transition metal at weak or broken parts of the film, reducing the oxidation and decomposition of the electrolyte solution at uncovered sites on the positive electrode surface.

The research of this disclosure found that, under the condition that the battery does not show obvious liquid expansion, the higher the areal density B of the positive electrode plate, the higher the content of the positive electrode active material, and the lower the relative content of the electrolyte solution to the positive electrode active material. When the total mass of the first additive and the second additive remains unchanged as a percentage of the total mass of the electrolyte solution, the higher the areal density B of the positive electrode plate, the lower the relative content of the first additive and the second additive to the positive electrode active material. If A<B/10, sufficient positive electrode protection (i.e., phosphorus-containing positive electrode protective film and coordination with the positive electrode transition metal) cannot be formed, which cannot reduce the consumption of the electrolyte solution and the damage to the positive electrode structure during the battery cycle, significantly deteriorating the high-temperature cycling performance and high-temperature storage performance of the battery at high voltage (4.53 V). Therefore, the content of A needs to be increased. When the battery satisfies A≥B/10, the electrolyte additive can form a stable and robust interface protection on the positive electrode surface, and the amount of the electrolyte additive can well match the areal density of the positive electrode, effectively improving the stability of the interface protective film on the positive electrode surface, significantly enhancing the stability of the electrolyte solution and the positive electrode interface, reducing the consumption of the electrolyte solution and the damage to the positive electrode structure during the battery cycle, and significantly improving the high-temperature cycling performance and high-temperature storage performance of the battery at high voltage (4.53 V).

In the present disclosure, A≥B/10, that is, B/A≤10. For example, the ratio of B/A can be 1, 2, 3, 4, 5, 6, 7, 8, 9, 10, or any point value within the range composed of the above two-point values.

According to the embodiments of the present disclosure, the battery satisfies the following relationship: A≥3/C, that is, A*C≥3, for example, A*C can be 3, 3.5, 4, 4.5, 5, 5.5, 6, 6.5, 7, 7.5, 8, 8.5, 9, 9.5, 10, or any point value within the range composed of the above two-point values, where A is the total mass of the first additive and the second additive as a percentage of the total mass of the electrolyte solution; C is a liquid retention coefficient of the battery, which is the ratio of the liquid retention mass (g) of the battery to the battery capacity (Ah).

The lower the liquid retention coefficient C of the battery, the lower a liquid retention mass relative to the battery capacity, and thus the lower the liquid retention mass relative to the content of the positive electrode active material. To achieve the same positive electrode protection effect, the proportion of the additive in the electrolyte solution must be increased. Research has found that when A≥3/C, sufficient interface protection can be formed at the positive electrode interface, significantly improving the high-temperature cycle and high-temperature storage performance of the battery at high voltage.

According to the embodiments of the present disclosure, the total mass of the first additive and the second additive accounts for 0.5%-5% of the total mass of the electrolyte solution, that is, A is 0.5-5. For example, it can be 0.5%, 0.6%, 0.7%, 0.8%, 0.9%, 1%, 1.2%, 1.5%, 1.6%, 1.8%, 2.0%, 2.2%, 2.4%, 2.5%, 2.6%, 2.7%, 2.8%, 3%, 3.4%, 3.5%, 4%, 4.5%, 4.8%, or 5%, or any point value within the range composed of the above two-point values. When the mass ratio of the first additive and the second additive is within the above range, it is beneficial for the electrolyte additive to form a more stable and robust protective layer on the positive electrode surface, significantly enhancing the stability of the electrolyte solution and the positive electrode interface, and effectively improving the high-temperature cycling performance and high-temperature storage performance of the battery under high voltage.

According to an embodiment of the present disclosure, the areal density of the positive electrode plate is 5 mg/cm²-30 mg/cm², that is, B is 5 to 30. For example, it can be 5 mg/cm², 6 mg/cm², 7 mg/cm², 8 mg/cm², 9 mg/cm², 10 mg/cm², 12 mg/cm², 13 mg/cm², 15 mg/cm², 18 mg/cm², 20 mg/cm², 22 mg/cm², 23 mg/cm², 24 mg/cm², 25 mg/cm², 26 mg/cm², 28 mg/cm², or 30 mg/cm², or any point value within the range composed of the above two-point values. In some embodiments, if the areal density of the positive electrode plate is too high (e.g., greater than 30 mg/cm²), the positive electrode plate will be too thick, resulting in poor kinetic performance of the battery and inability to charge and discharge normally. If the areal density of the positive electrode plate is too low (e.g., less than 5 mg/cm²), the overall energy density of the battery will be too low to meet disclosure requirements.

According to an embodiment of the present disclosure, the liquid retention coefficient C is 1 g/Ah-2 g/Ah, that is, C is 1 to 2. For example, it can be 1.0 g/Ah, 1.1 g/Ah, 1.2 g/Ah, 1.3 g/Ah, 1.4 g/Ah, 1.5 g/Ah, 1.6 g/Ah, 1.7 g/Ah, 1.8 g/Ah, 1.9 g/Ah, 2.0 g/Ah, or any point value within the range composed of the above two-point values. If the liquid retention coefficient is too low, the electrolyte solution content (battery liquid retention mass) will be too small, significantly deteriorating the battery cycling performance. If the liquid retention coefficient is too high, the energy density of the battery will be too low to meet practical disclosure requirements. A simple test method for the liquid retention coefficient is as follows: charge the cell to the cut-off voltage at 0.2C, then discharge it to the cut-off voltage at 0.2C to obtain the cell capacity DC. Weigh the entire cell as G1, then disassemble the cell, soak the disassembled cell in a large amount of DMC (dimethyl carbonate), fully dry the soaked cell, and weigh it as G2. The liquid retention coefficient is (G1−G2)/DC.

According to the embodiments of the present disclosure, the battery satisfies the following relationship: 2A/3≥X≥A/5, that is, 1/5≤X/A≤2/3 (X/A can be 0.2, 0.24, 0.28, 0.32, 0.36, 0.4, 0.44, 0.48, 0.52, 0.56, 0.6, 0.64, etc.), where X is the mass percentage of the tricyanophosphite compound in the total mass of the electrolyte solution.

According to an embodiment of the present disclosure, when the battery satisfies 2A/3≥X≥A/5, the tricyanophosphite compound and the alkyl polycyanide compound in the electrolyte solution can better exert a synergistic effect, forming a sufficiently robust and stable protective layer.

According to the embodiments of the present disclosure, the battery satisfies the following relationship: Y=A−X, where Y is the mass percentage of the alkyl polycyanide compound in the total mass of the electrolyte solution.

According to an embodiment of the present disclosure, the mass percentage X of the tricyanophosphite compound in the total mass of the electrolyte solution is 0.1%-3.3%, for example, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3.0%, 3.1%, 3.2%, or 3.3%, or any point value within the range composed of the above two-point values, preferably 0.5%-2.5%. The preferred mass proportion of the tricyanophosphite compound can further enhance the protection of the positive electrode, improving the high-temperature cycling performance and high-temperature storage performance of the battery under high voltage.

According to an embodiment of the present disclosure, the tricyanophosphite compound has the structural formula shown in Formula (1):

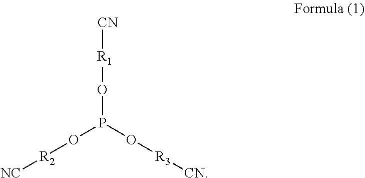

In Formula (1), R₁, R₂, and R₃ are independently selected from unsubstituted or optionally substituted (with one, two, or more Ra groups) C₁₋₁₀ alkylene, C₆₋₁₂ arylene, or —C₁₋₁₀ alkylene-C(═O)—O—C₁₋₁₀ alkylene-, where each Rₐ is independently selected from halogen, or C₁₋₁₀ alkyl.

That is, in Formula (1), R₁, R₂, and R₃ are independently selected from substituted or unsubstituted C₁₋₁₀ alkylene, substituted or unsubstituted C₆₋₁₂ arylene, or substituted or unsubstituted —C₁₋₁₀ alkylene-C(═O)—O—C₁₋₁₀ alkylene-, where the substituent is Rₐ, and each Rₐ is independently selected from halogen, or C₁₋₁₀ alkyl.

According to an embodiment of the present disclosure, in Formula (1), R₁, R₂, and R₃ are independently selected from unsubstituted or optionally substituted C₁₋₆ alkylene, C₆₋₈ arylene, or —C₁₋₆ alkylene-C(═O)—O—C₁₋₆ alkylene-, where each Rₐ is independently selected from halogen or C₁₋₆ alkyl. That is, in Formula (1), R₁, R₂, and R₃ are independently selected from substituted or unsubstituted C₁₋₆ alkylene, substituted or unsubstituted C₆₋₈ arylene, or, substituted or unsubstituted —C₁₋₆ alkylene-C(═O)—O—C₁₋₆ alkylene-, where the substituent is Rₐ, and each Rₐ is independently selected from halogen or C₁₋₆ alkyl.

According to the embodiments of the present disclosure, in formula (1), R₁, R₂, and R₃ are independently selected from unsubstituted or optionally substituted C₁₋₃ alkylene, phenylene, or —C1-3 alkylene-C(═O)—O—C₁₋₃ alkylene-, each Rₐ is independently selected from halogen, or C₁₋₃ alkyl. That is, in formula (1), R₁, R₂, and R₃ are independently selected from substituted or unsubstituted C₁₋₃ alkylene, substituted or unsubstituted phenylene, or substituted or unsubstituted —C₁₋₃ alkylene-C(═O)—O—C₁₋₃ alkylene-, the substituent being Rₐ, each Rₐ is independently selected from halogen, or C₁₋₃ alkyl.

According to the embodiments of the present disclosure, in formula (1), R₁, R₂, and R₃ are independently selected from substituted or unsubstituted —CH₂—, substituted or unsubstituted —CH₂CH₂—, substituted or unsubstituted —CH₂CH₂CH₂—, substituted or unsubstituted —CH₂CH(CH₃)—, substituted or unsubstituted ortho-phenylene, substituted or unsubstituted meta-phenylene, substituted or unsubstituted para-phenylene, substituted or unsubstituted —CH₂—C(═O)—O—CH₂—, or substituted or unsubstituted —CH₂CH₂—C(═O)—O—CH₂CH₂—, where the substituent is Rₐ, and each Rₐ is independently selected from F, —CH₃, —CH₂CH₃, —CH₂CH₂CH₃, or —CH(CH₃)CH₃.

According to the embodiments of the present disclosure, the tricyanophosphite compound includes at least one of the compounds shown in formulas (2) to (9).

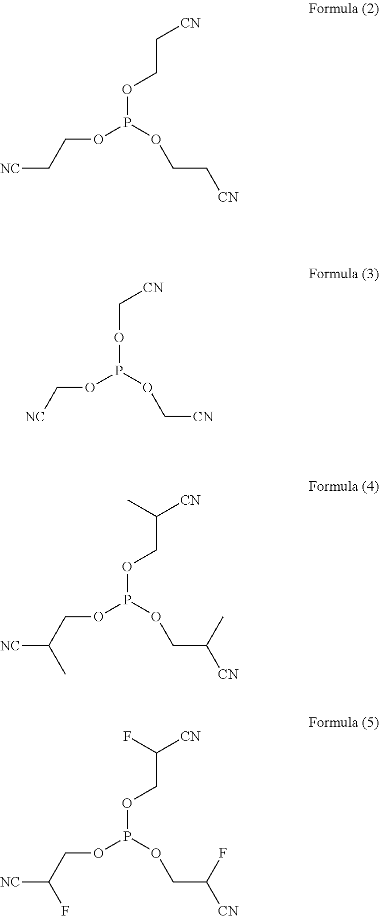 [SMILES: N#CCCOP(OCCC#N)OCCC#N ; N#CCOP(OCC#N)OCC#N ; CC(C#N)COP(OCC(C)C#N)OCC(C)C#N ; N#CC(F)COP(OCC(F)C#N)OCC(F)C#N]

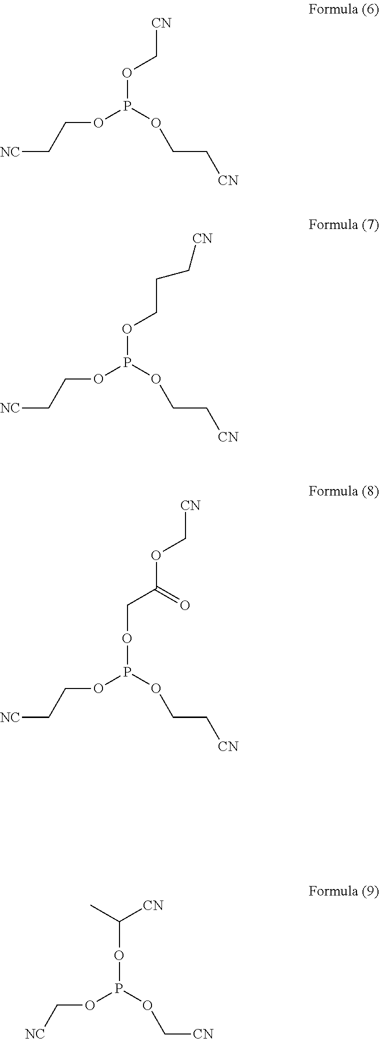 [SMILES: N#CCCOP(OCC#N)OCCC#N ; N#CCCCOP(OCCC#N)OCCC#N ; N#CCCOP(OCCC#N)OCC(=O)OCC#N ; CC(C#N)OP(OCC#N)OCC#N]

According to the embodiments of the present disclosure, the tricyanophosphite compound can be obtained through commercial channels or prepared using methods known in the art.

According to the embodiments of the present disclosure, the alkyl polycyanide compound has the chemical formula shown in formula (10):

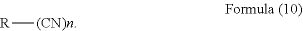

In formula (10), R is an alkyl group, and n is an integer greater than or equal to 3.

According to the embodiments of the present disclosure, in formula (10), R is C3-8 alkyl, such as n-propyl, n-butyl, n-pentyl, n-hexyl, n-heptyl, n-octyl, or their isomeric groups.

According to the embodiments of the present disclosure, in formula (10), n is 3 or 4. When n is 3 or 4, the alkyl polycyanide compounds are tricyano compounds or tetracyano compounds, which can provide more cyano functional groups, further enhance the coordination between the alkyl polycyanide compounds and transition metals at the positive electrode interface, strengthen the protection of the positive electrode, and further reduce the oxidation and decomposition of the electrolyte solution at uncovered sites on the positive electrode surface.

According to the embodiments of the present disclosure, the alkyl polycyanide compound includes at least one of 1,3,6-hexanetricarbonitrile (HTCN, NC(CH₂)₃CH(CN)CH₂CH₂CN), 1,2,3-propanetricarbonitrile, or 1,2,2,3-tetracyanopropane.

According to the embodiments of the present disclosure, the alkyl polycyanide compound can be obtained through commercial channels or prepared using methods known in the art.

According to the embodiments of the present disclosure, the electrolyte solution further includes a third additive, and the third additive includes at least one of adiponitrile (ADN), succinonitrile, fluoroethylene carbonate (FEC), 1,3-propane sultone (PS), or 1,3-propene sultone.

According to the embodiments of the present disclosure, the weight of the third additive is 0 wt %-15 wt % of the total weight of the electrolyte solution, such as 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 9 wt %, 10 wt %, 11 wt %, 12 wt %, 13 wt %, 14 wt %, or 15 wt %, or any point value within the range formed by the above two-point values. Under the combined action of the third additive with the first and second additives, both the positive electrode and negative electrode can be protected simultaneously, improving the high-temperature cycling performance and high-temperature storage performance of the battery at high voltage.

According to the embodiments of the present disclosure, the lithium salt includes one or more of lithium hexafluorophosphate (LiPF₆), lithium difluorophosphate (LiPO₂F₂), lithium difluorooxalatoborate (LiDFOB), lithium bis(trifluoromethanesulfonyl)imide, lithium difluorobis(oxalato)phosphate, lithium tetrafluoroborate, lithium bis(oxalato)borate, lithium hexafluoroantimonate, lithium hexafluoroarsenate, lithium bis(pentafluoroethanesulfonyl)imide, lithium tris(trifluoromethanesulfonyl)methide, or lithium bis(trifluoromethanesulfonyl)imide.

According to the embodiments of the present disclosure, the mass percentage of the lithium salt accounts for 10 wt %-15 wt % of the total mass of the electrolyte solution, for example, 10 wt %, 11 wt %, 12 wt %, 13 wt %, 14 wt %, or 15 wt %, or any point value within the range composed of the above two points.

According to the embodiments of the present disclosure, the organic solvent includes carbonate and/or carboxylic acid ester, and the carbonate includes one or more of the following fluorinated or non-fluorinated solvents: ethylene carbonate (EC), propylene carbonate (PC), dimethyl carbonate, diethyl carbonate (DEC), ethyl methyl carbonate; the carboxylate includes one or more of the following fluorinated or non-fluorinated solvents: propyl acetate, n-butyl acetate, isobutyl acetate, n-amyl acetate, isoamyl acetate, propyl propionate (PP), ethyl propionate (EP), methyl butyrate, ethyl n-butyrate.

According to the embodiments of the present disclosure, the positive electrode plate includes a positive electrode current collector and a positive electrode active material layer coated on one or both surfaces of the positive electrode current collector, and the positive electrode active material layer includes a positive electrode active material, a conductive agent, and a binder.

According to the embodiments of the present disclosure, the mass percentage of each component in the positive electrode active material layer is: 80 wt %-99.8 wt % of the positive electrode active material, 0.1 wt %-10 wt % of the conductive agent, and 0.1 wt %-10 wt % of the binder.

Preferably, the mass percentage of each component in the positive electrode active material layer is: 90 wt %-99.6 wt % of the positive electrode active material, 0.2 wt %-5 wt % of the conductive agent, and 0.2 wt %-5 wt % of the binder.

According to the embodiments of the present disclosure, the mass percentage of each component in the negative electrode active material layer is: 80 wt %-99.8 wt % of a negative electrode active material, 0.1 wt %-10 wt % of a conductive agent, and 0.1 wt %-10 wt % of a binder.

Preferably, the mass percentage of each component in the negative electrode active material layer is: 90 wt %-99.6 wt % of the negative electrode active material, 0.2 wt %-5 wt % of the conductive agent, and 0.2 wt %-5 wt % of the binder.

According to the embodiments of the present disclosure, the conductive agent includes at least one of conductive carbon black, acetylene black, Keqin black conductive graphite, conductive carbon fiber, carbon nanotubes, metal powder, or carbon fiber.

According to the embodiments of the present disclosure, the binder includes at least one of sodium carboxymethyl cellulose, styrene-butadiene rubber latex, polytetrafluoroethylene, or polyethylene oxide.

According to the embodiments of the present disclosure, the negative electrode active material is at least one of a silicon-based negative electrode material and a carbon-based negative electrode material.

According to the embodiments of the present disclosure, the carbon-based negative electrode material includes at least one of artificial graphite, natural graphite, mesocarbon microbead, hard carbon, or soft carbon.

According to the embodiments of the present disclosure, the silicon-based negative electrode material includes at least one of a silicon-carbon negative electrode material or a silicon-oxygen negative electrode material.

According to the embodiments of the present disclosure, the negative electrode active material is silicon-carbon/graphite and/or silicon-oxygen/graphite.

According to the embodiments of the present disclosure, the positive electrode active material includes one or more of a transition metal lithium oxide, lithium iron phosphate, or lithium manganate; the chemical formula of the transition metal lithium oxide is Li₁₊ₓNi_{y}Co_{z}M_{(1-y-z)}O₂, where −0.1≤x≤1; 0≤y≤1, 0≤z≤1, and 0≤y+z≤1; where M is one or more of Mg, Zn, Ga, Ba, Al, Fe, Cr, Sn, V, Mn, Sc, Ti, Nb, Mo, or Zr.

The beneficial effects of the present disclosure are as follows.

The present disclosure provides a battery, which includes a positive electrode plate, a negative electrode plate, a separator, and an electrolyte solution. The additives of the electrolyte include a tricyanophosphite compound and an alkyl polycyanide compound. The battery can solve the problem of large side reactions between the electrolyte solution and the electrode interface under high voltage, and the significant deterioration of high-temperature cycling performance and high-temperature storage performance of the battery under high voltage. By adding an appropriate amount of electrolyte additive according to the areal density of the positive electrode, the positive electrode can have a very stable interface film and interface coordination effect, significantly improving the stability of the electrolyte solution and the positive electrode interface, reducing the consumption of the electrolyte solution and the damage to the positive electrode structure during the battery cycle, and significantly improving the high-temperature cycling performance and high-temperature storage performance of the battery under high voltage. Experimental verification has shown that the battery provided by the present disclosure can achieve a cycle capacity retention rate of 80% at 45° C. for up to 562 cycles, and the thickness expansion rate at 60° C. storage can be as low as 5.9%.

The lithium-ion battery is prepared through the following steps.

### (1) Preparation of Positive Electrode Plate

The positive electrode active material lithium cobalt oxide (LiCoO₂), polyvinylidene fluoride (PVDF), SP (super P), and carbon nanotubes (CNT) are mixed in a mass ratio of 96:2:1.5:0.5, and N-methylpyrrolidone (NMP) is added, and the mixture is stirred under the action of a vacuum mixer until the mixed system becomes a uniformly flowing positive electrode active slurry; the positive electrode active slurry is uniformly coated on both surfaces of an aluminum foil; the coated aluminum foil is dried, and then rolled and cut to obtain the required positive electrode plate, and the areal density of the positive electrode is B mg/cm² (the specific areal density is as described in Table 1).

### (2) Preparation of Negative Electrode Plate

Mix the negative active material silicon carbon/artificial graphite (containing 5% silicon carbon and 95% artificial graphite), sodium carboxymethyl cellulose (CMC-Na), styrene-butadiene rubber, conductive carbon black (SP), and single-walled carbon nanotubes (SWCNTs) in a mass ratio of 94.5:2.5:1.5:1:0.5, add deionized water, and obtain the negative active slurry under the action of a vacuum mixer; uniformly coat the negative active slurry on both surfaces of the copper foil; dry the coated copper foil at room temperature, then transfer to an 80° C. oven to dry for 10 hours, and then obtain the negative electrode plate through cold pressing and slitting.

### (3) Preparation of Electrolyte Solution

In an argon-filled glove box (H₂O<0.1 ppm, O₂<0.1 ppm), mix EC/PC/DEC/PP uniformly in a mass ratio of 10/20/40/30, then quickly add 1 mol/L of fully dried lithium hexafluorophosphate (LiPF₆), after dissolution, add 12 wt % of fluoroethylene carbonate based on the total mass of the electrolyte solution, 2 wt % of 1,3-propane sultone, 1 wt % of adiponitrile, tricyanophosphitecompounds, and alkyl polycyanide compounds (specific amounts as described in Table 1), stir uniformly, and obtain the required electrolyte solution after passing the water and free acid tests.

### (4) Preparation of Lithium-ion Battery

Stack the positive electrode plate from step 1), the negative electrode plate from step 2), and a separator in the order of positive electrode plate, separator, and negative electrode plate, then wind to obtain the cell; place the cell in the outer packaging aluminum foil, inject the electrolyte solution from step 3) into the outer packaging, and obtain the lithium-ion battery through vacuum sealing, standing, formation, shaping, and sorting processes. The charge and discharge range of the disclosed battery is 3.0 V-4.53 V.

Perform 45° C. cycling performance tests and 60° C. storage performance tests on the lithium-ion batteries obtained from the examples and comparative examples, respectively. The test results are shown in Table 2.

### (1) 45° C. Cycling Performance Test

Charge and discharge the batteries in Table 1 at 45° C. at a rate of 1 C within the charge and discharge cutoff voltage range, test the discharge capacity in the first week as x2 mAh, and the discharge capacity in the Nth week as y2 mAh; divide the capacity in the Nth week by the capacity in the first week to obtain the cycle capacity retention rate R=y2/x2 in the Nth week, and record the cycle number when the cycle capacity retention rate R is 80%.

### (2) 60° C. Storage Performance Test

Charge the batteries in Table 1 at 25° C. at a rate of 1 C to the cutoff voltage, cutoff current 0.025C, stand for 5 minutes, and test the thickness of the lithium-ion battery (this is the thickness before storage). Fully charged cells/batteries are placed open-circuit at (60±2°) C for 35 days, after 35 days of storage, place open-circuit at room temperature for 2 hours, measure the cold thickness after storage, and calculate the thickness expansion rate of the lithium-ion battery:

$$Thickness expansion rate = [ ( thickness after storage - thickness before storage ) / thickness before storage ] \times 100 \% .$$

### (3) Simple Test of Liquid Retention Coefficient

Charge the batteries in Table 1 at 0.2C to the cutoff voltage, then discharge at 0.2C to the cutoff voltage to obtain the cell capacity DC, then weigh the entire cell as G1, then disassemble the cell, soak the disassembled cell in a large amount of dimethyl carbonate (DMC), fully dry the soaked cell, and weigh it again as G2, then the liquid retention coefficient is (G1−G2)/DC.

TABLE 1
Composition of Batteries in Examples and Comparative Examples

| | | Alkyl | Tricyanophosphite | | | |
|---|---|---|---|---|---|---|
| | | polycyanide | compounds | | | |
| | Areal | compounds | Content X of | Content X of | | |
| | density of | Content Y of | Compound | Compound | | |
| | positive | 1,3,6-Hexane | shown in | shown in | Total content | Liquid |
| | electrode B | trinitrile Y, | formula (2), | formula (4), | of additives | retention |
| | mg/cm² | wt % | wt % | wt % | A, wt % | coefficient C, |
| Comparative | 20 | / | / | / | / | 1.5 |
| Example 1 | | | | | | |
| Comparative | 20 | / | 0.5 | / | 0.5 | 1.5 |
| Example 2 | | | | | | |
| Comparative | 20 | 1 | 0.5 | / | 1.5 | 1.5 |
| Example 3 | | | | | | |
| Comparative | 20 | 2 | / | / | 2 | 1.5 |
| Example 4 | | | | | | |
| Comparative | 20 | 2.5 | / | / | 2.5 | 1.5 |
| Example 5 | | | | | | |
| Comparative | 20 | / | 2.5 | / | 2.5 | 1.5 |
| Example 6 | | | | | | |
| Comparative | 35 | / | / | / | / | 1.5 |
| Example 7 | | | | | | |
| Comparative | 20 | 2 | 0.5 | / | 2.5 | 0.8 |
| Example 8 | | | | | | |
| Example 1 | 20 | 2 | 0.5 | / | 2.5 | 1.5 |
| Example 2 | 20 | 2 | 1 | / | 3 | 1.5 |
| Example 3-1 | 20 | 2 | / | 1 | 3 | 1.5 |
| Example 3-2 | 20 | 2 | / | 0.5 | 2.5 | 1.5 |
| Example 3-3 | 20 | 2 | / | 2.5 | 4.5 | 1.5 |
| Example 4 | 20 | 0.5 | 2.5 | / | 3 | 1.5 |
| Example 5 | 20 | 2.5 | 0.5 | / | 3 | 1.5 |
| Example 6 | 20 | 2 | 1.5 | / | 3.5 | 1.5 |
| Example 7 | 20 | 3 | 1 | / | 4 | 1.5 |
| Example 8 | 20 | 4 | 1 | / | 5 | 1.5 |
| Example 9 | 35 | 3 | 0.5 | / | 3.5 | 1.5 |
| Example 10 | 20 | 2 | 1 | 1 | 3 | 1.7 |

### Example Group 11

Refer to Example 6, with the difference being the type of alkyl polycyanide compound changed.

Example 11a: Replace 1,3,6-hexane trinitrile with an equivalent amount of 1,2,3-propanetricarbonitrile.

Example 11b: Replace 1,3,6-hexane trinitrile with an equivalent amount of 1,2,2,3-tetracyanopropane.

Example 11b: Replace 1,3,6-hexane trinitrile with an equivalent amount of 1,2,3-propanetricarbonitrile and 1,2,2,3-tetracyanopropane (mass ratio 1:1).

### Example Group 12

Refer to Example 6, with the difference being the type of tricyanophosphite compound changed.

Example 12a: Replace the compound shown in formula (2) with an equivalent amount of the compound shown in formula 5.

Example 12b: Replace the compound shown in formula (2) with an equivalent amount of the compound shown in formula 8.

Example 12c: The compound shown in formula (2) accounts for 0.75 wt %, and the compound shown in formula (4) accounts for 0.75 wt %.

### Example Group 13

Refer to Example group 11, with the difference being the content of alkyl polycyanide compound changed.

Example 13a: Compared with Example 11a, the content of 1,2,3-propanetricarbonitrile accounts for 1%.

Example 13b: Compared with Example 11a, the content of 1,2,3-propanetricarbonitrile accounts for 2.5%.

Example 13c: Compared with Example 11b, the content of 1,2,2,3-tetracyanopropane accounts for 1%.

Example 13d: Compared with Example 11b, the content ratio of 1,2,2,3-tetracyanopropane is 0.5%.

### Example Group 14

Refer to Example group 12 for implementation, with the difference being the change in the content of tricyanophosphite compounds.

Example 14a: Compared with Example 12a, the content ratio of the compound shown in Formula 5 is 0.5 wt %.

Example 14b: Compared with Example 12a, the content ratio of the compound shown in Formula 5 is 2.5 wt %.

Example 14c: Compared with Example 12b, the content ratio of the compound shown in Formula 8 is 0.5 wt %.

Example 14d: Compared with Example 12b, the content ratio of the compound shown in Formula 8 is 2.5 wt %.

### Example Group 15

Refer to Example 6, with the difference being the type and content of the third additive changed.

Example 15a: The third additive is 8 wt % fluoroethylene carbonate, 2 wt % 1,3-propane sultone, and 2.5 wt % adiponitrile; the total content ratio of the third additive is reduced.

Example 15b: The third additive is 12 wt % fluoroethylene carbonate, 2 wt % 1,3-propane sultone, and 1 wt % succinonitrile.

Example 15c: The third additive is 14 wt % fluoroethylene carbonate and 1 wt % adiponitrile.

TABLE 2
Cycling Performance Test Results Of Lithium-Ion
Batteries In Examples And Comparative Examples

| | Cycles to achieve | |
|---|---|---|
| | 80% capacity | Thickness expansion |
| | retention at 45° C. | rate of 60° C. |
| | cycling conditions | stored battery |
| Comparative Example 1 | 336 | 22.3% |
| Comparative Example 2 | 356 | 21.2% |
| Comparative Example 3 | 398 | 16.8% |
| Comparative Example 4 | 421 | 15.5% |
| Comparative Example 5 | 477 | 12.8% |
| Comparative Example 6 | 455 | 14.1% |
| Comparative Example 7 | 136 | 36.3% |
| Comparative Example 8 | 279 | 17.9% |
| Example 1 | 535 | 8.8% |
| Example 2 | 557 | 7.2% |
| Example 3-1 | 514 | 8.9% |
| Example 3-2 | 491 | 9.7% |
| Example 3-3 | 537 | 8.1% |
| Example 4 | 489 | 11.8% |
| Example 5 | 499 | 8.9% |
| Example 6 | 562 | 6.7% |
| Example 7 | 549 | 6.8% |
| Example 8 | 554 | 5.9% |
| Example 9 | 227 | 21.1% |
| Example 10 | 581 | 7.3% |
| Example 11a | 528 | 7.2% |
| Example 11b | 557 | 7.0% |
| Example 11c | 541 | 7.1% |
| Example 12a | 577 | 6.6% |
| Example 12b | 559 | 6.7% |
| Example 12c | 543 | 7.1% |
| Example 13a | 503 | 8.4% |
| Example 13b | 537 | 7.1% |
| Example 13c | 523 | 7.8% |
| Example 13d | 505 | 8.3% |
| Example 14a | 526 | 7.7% |
| Example 14b | 592 | 6.5% |
| Example 14c | 511 | 7.9% |
| Example 14d | 576 | 6.6% |
| Example 15a | 543 | 6.9% |
| Example 15b | 568 | 6.6% |
| Example 15c | 528 | 8.6% |

From the above performance test results, it can be seen that in Comparative Examples 1-2 and 4-6, where 1,3,6-hexanetricarbonitrile and tricyanophosphite compound were not added simultaneously, the high-temperature cycling performance and high-temperature storage of the obtained batteries were significantly worse than those of Example 1. In Comparative Example 3, where 1,3,6-hexanetricarbonitrile and tricyanophosphite compounds were added simultaneously, the performance improved compared to Comparative Example 1, but due to insufficient additive content, it was difficult to form adequate positive electrode protection, and the performance was also significantly poor.

From the comparison of Examples 1-8, it can be seen that when 1,3,6-hexanetricarbonitrile and tricyanophosphite compound were added to the electrolyte solution system, the high-temperature cycling performance and high-temperature storage performance of the obtained batteries were significantly improved compared to Comparative Examples 1-6, but as the content of the two additives increased, the improvement in the high-temperature cycling performance and high-temperature storage performance of the batteries gradually decreased. The areal density of the positive electrode plate in Example 9 was too high, leading to a significant deterioration in the various performances of the battery compared to Examples 1-8. However, compared to Comparative Example 7, the high-temperature cycling performance and high-temperature storage performance of the battery in Example 9 also showed significant improvement.

From the comparison of Comparative Example 8 and Example 1, it can be seen that when the liquid retention coefficient is too low, the performance of the battery significantly deteriorates. From Example 2 and Example 10, it can be seen that when the liquid retention coefficient is improved, the battery cycling performance slightly improves.

From the comparison of Example 2-Example 3, as well as Example 6 and Example 12a-12b, it can be seen that adjusting the structural formula of the tricyanophosphite compound slightly affects the battery performance, but overall, batteries with good high-temperature storage and cycling performance under high voltage are obtained; among them, the cycling performance of Example 12a is better than that of Example 6, because the tricyanophosphite compound in Example 12a contains fluorine, which enhances the oxidation resistance of the tricyanophosphite compound, making it more stable and long-lasting in the positive electrode. At the same time, from the comparison of Example 2-5, it can be seen that when the amount of the first additive in the electrolyte solution of Example 4 and 5 does not meet the condition 2A/3≥X≥A/5, the high-temperature cycle and storage performance of the battery is slightly worse than that of Example 2 and 3.

Above, the embodiments of the present disclosure have been described. However, the present disclosure is not limited to the above embodiments. Any modifications, equivalent replacements, improvements, etc., made within the spirit and principles of the present disclosure shall be included within the protection scope of the present disclosure.

What is claimed is:

1. A battery, comprising a positive electrode plate, a negative electrode plate, a separator, and an electrolyte solution, the electrolyte comprising a lithium salt, an organic solvent, a first additive, and a second additive, the first additive comprising a tricyanophosphite compound, the second additive comprising an alkyl polycyanide compound;
wherein the battery satisfies the following relationship:
$$A \geq B / 10 ,$$
wherein, A is a total mass percentage of the first additive and the second additive in the total mass of the electrolyte solution; B is the areal density of the positive electrode, in units of mg/cm².

2. The battery according to claim 1, wherein the battery also satisfies the following relationship:
$$A \geq 3 / C ,$$
wherein, A is the total mass percentage of the first additive and the second additive in the total mass of the electrolyte solution; C is a liquid retention coefficient of the battery, which is the ratio of the liquid retention mass (g) of the battery to the battery capacity (Ah).

3. The battery according to claim 1, wherein the total mass percentage A of the first additive and the second additive in the total mass of the electrolyte solution is 0.5%-5%.

4. The battery according to claim 1, wherein the areal density B of the positive electrode plate is 5 mg/cm²-30 mg/cm².

5. The battery according to claim 2, wherein the liquid retention coefficient C is 1 g/Ah-2 g/Ah.

6. The battery according to claim 1, wherein the battery satisfies the following relationship:
$$2 A / 3 \geq X \geq A / 5 ,$$
wherein X is the mass percentage of the tricyanophosphite compound in the total mass of the electrolyte.

7. The battery according to claim 6, wherein the mass percentage X of the tricyanophosphite compound in the total mass of the electrolyte solution is 0.1%-3.3%.

8. The battery according to claim 1, wherein the tricyanophosphite compound has the structural formula shown in formula (1): 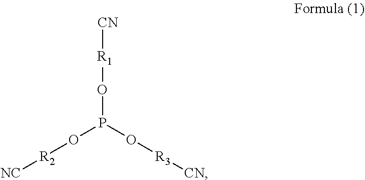
in formula (1), R₁, R₂, and R₃ are independently selected from substituted or unsubstituted C₁₋₁₀ alkylene, substituted or unsubstituted C₆₋₁₂ arylene, or, substituted or unsubstituted —C₁₋₁₀ alkylene-C(═O)—O—C₁₋₁₀ alkylene-, wherein a substituent is Rₐ, and each Rₐ is independently selected from halogen or C₁₋₁₀ alkyl.

9. The battery according to claim 8, wherein in formula (1), R₁, R₂, and R₃ are independently selected from substituted or unsubstituted C₁₋₆ alkylene, substituted or unsubstituted C₆₋₈ arylene, or, substituted or unsubstituted —C₁₋₆ alkylene-C(═O)—O—C₁₋₆ alkylene-, wherein the substituent is Rₐ, and each Rₐ is independently selected from halogen or C₁₋₆ alkyl.

10. The battery according to claim 8, wherein in formula (1), R₁, R₂, and R₃ are independently selected from substituted or unsubstituted —CH₂—, substituted or unsubstituted —CH₂CH₂—, substituted or unsubstituted —CH₂CH₂CH₂—, substituted or unsubstituted —CH₂CH(CH₃)—, substituted or unsubstituted ortho-phenylene, substituted or unsubstituted meta-phenylene, substituted or unsubstituted para-phenylene, substituted or unsubstituted —CH₂—C(═O)—O—CH₂—, or, substituted or unsubstituted —CH₂CH₂—C(═O)—O—CH₂CH₂—, the substituent is Rₐ, and each Rₐ is independently selected from F, —CH₃, —CH₂CH₃, —CH₂CH₂CH₃, or —CH(CH₃)CH₃.

11. The battery according to claim 1, wherein the tricyanophosphite compound comprises at least one of the compounds shown in formulas (2) to (9):

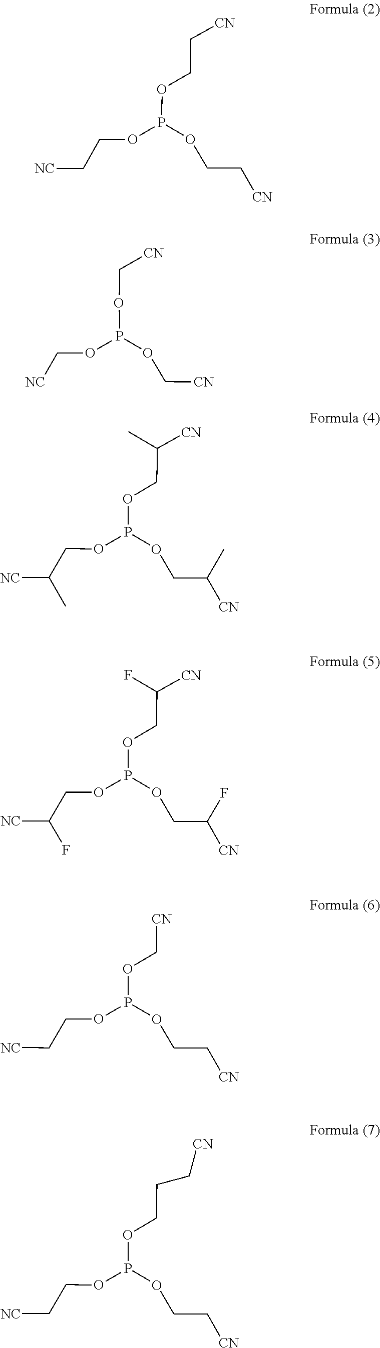 [SMILES: N#CCCOP(OCCC#N)OCCC#N ; N#CCOP(OCC#N)OCC#N ; CC(C#N)COP(OCC(C)C#N)OCC(C)C#N ; N#CC(F)COP(OCC(F)C#N)OCC(F)C#N ; N#CCCOP(OCC#N)OCCC#N ; N#CCCCOP(OCCC#N)OCCC#N]

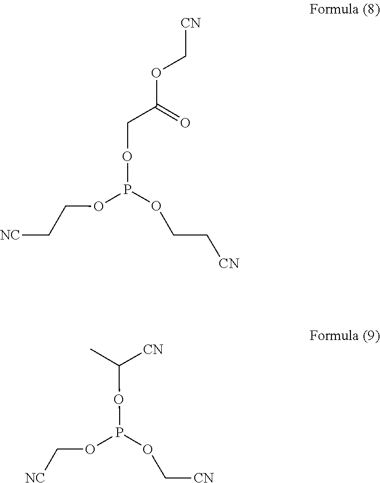 [SMILES: N#CCCOP(OCCC#N)OCC(=O)OCC#N ; CC(C#N)OP(OCC#N)OCC#N]

12. The battery according to claim 1, wherein the alkyl polycyanide compound comprises a chemical formula shown in formula (10); 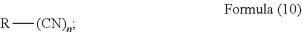
in formula (10), R is an alkyl group, and n is an integer greater than or equal to 3.

13. The battery according to claim 12, wherein in formula (10), R is C₃₋₈ alkyl; and/or, n is 3 or 4.

14. The battery according to claim 1, wherein the alkyl polycyanide compound comprises at least one of 1,3,6-hexanetricarbonitrile, 1,2,3-propanetricarbonitrile, or 1,2,2,3-tetracyanopropane.

15. The battery according to claim 1, wherein the electrolyte solution further comprises a third additive, and the third additive comprises at least one of adiponitrile, succinonitrile, fluoroethylene carbonate, 1,3-propanesultone, or 1,3-propenesultone.

16. The battery according to claim 15, wherein the weight of the third additive is 0 wt %-15 wt % of the total weight of the electrolyte solution.
